(19) United States
(12) Patent Application Publication
(10) Pub. No.: US 2013/0332727 A1
(43) Pub. Date: Dec. 12, 2013

(54) ACCESS TOKEN EVENT VIRTUALIZATION

(71) Applicant: AVENTURA HQ, INC., Denver, CO (US)

(72) Inventors: Joe Jaudon, Sedalia, CO (US); David Lowrey, Denver, CO (US); Adam Williams, Aurora, CO (US)

(73) Assignee: Aventura HQ, Inc., Denver, CO (US)

(21) Appl. No.: 13/787,206

(22) Filed: Mar. 6, 2013

Related U.S. Application Data
(60) Provisional application No. 61/656,116, filed on Jun. 6, 2012.

(51) Int. Cl. H04L 29/06

(52) U.S. Cl. CPC H04L 63/0807
USPC 713/159

(57) ABSTRACT

Systems, devices, and methods are disclosed for access token event virtualization. An access token may be received at a central server computer system from a terminal device. The access token event may indicate that an access device associated with the terminal device has received an access token. A virtual session associated with the received access token event may be identified at the central server computer system, and a set of rules may be applied to the received access token event and the identified virtual session to determine an action associated with the identified virtual session. The central server computer system may transmit an instruction to at least one device communicatively coupled with the central server computer system to carry out the action associated with the identified virtual session.

### CROSS-REFERENCE TO RELATED APPLICATIONS

The present claims priority to U.S. Provisional Patent Application No. 61/656,116, entitled “ACCESS TOKEN EVENT VIRTUALIZATION,” which was filed on Jun. 6, 2012, and is incorporated herein by reference for all purposes.

### BACKGROUND

The present invention relates to the processing of data received from access devices in a network.

In some networks, access control devices, such as proximity card readers, biometric scanners, keypads, and the like are used to control access to terminal devices, locations, and other resources. In these systems, a user may provide an access token (e.g., proximity card data, biometric data, PIN, etc.) to the access control device to request access to a particular resource. Based on a set of permissions associated with that access token, a determination is made whether to grant or deny access to the user.

Many access control devices are peripherally connected to some type of host computer, such as a terminal device. In this type of system, an access control device receiving an access token will generally pass the access token to a local operating system associated with the host computer for processing. Thus, access control events associated with access control devices are typically unavailable for use in a broader network management context.

### SUMMARY

Methods, systems, and devices are described for synchronizing application services across disparate devices in a network using a centralized network synchronization service.

According to a first set of illustrative embodiments, an access token event may be received at a central computer server system from a terminal device, the access token event indicating that an access device associated with the terminal device has received an access token. A virtual session associated with the received access token event may be identified, and a set of rules may be applied to the received access token event and the identified session to determine an action to be taken with respect to the identified session. An instruction may then be transmitted to at least one device communicatively coupled with the central server computer system to carry out the action with respect to the identified session.

In certain examples, the method may include communicating with the terminal device to cause the terminal device to prompt a user associated with the access token for at least one authentication credential, and receiving the at least one authentication credential at the central server computer system from the terminal device. The user may be authenticated based on the at least one authentication credential; and the identified virtual session may be associated with the terminal device at the central server computer system in response to the authentication of the user based on the at least one authentication credential.

In certain examples, the at least one device communicatively coupled with the central server computer system may be the terminal device, and the action associated with the identified virtual session may include selectively forwarding session data for the virtual session between the central server computer system and the terminal device. The central server computer system may further determine that a user associated with the virtual session has moved to a location of the terminal device based on the received access token event. In such examples, the selectively forwarding the session data for the virtual session between the central server computer system and the terminal device may occur in response to the determination that the user has moved to the location of the terminal device.

In certain examples, the method may further include updating at least one aspect of the virtual session based on the determination that the user has moved to the location of the terminal device. In certain examples the action associated with the virtual session may include causing a user interface for the virtual session to be displayed at the terminal device. In certain examples, the at least one device communicatively coupled with the central server computer system may include a second terminal device associated with the virtual session.

In certain examples, the action associated with the virtual session may include disassociating the second terminal device from the virtual session at the central server computer system in response to receiving the access token event. The action associated with the virtual session may further include logging the user off of the second terminal device.

In certain examples, the action associated with the virtual session may include prompting a user of the second terminal device to enter at least one authentication credential. The at least one authentication credential may be received from the second terminal device. The transmission of the instruction to carry out the action associated with the identified virtual session may occur in response to the at least one authentication credential received from the second terminal device

According to a second set of illustrative embodiments, a central server computer system configured to manage access tokens may include an access token event module, a session module, a rules engine module, and an instruction module. The access token event module may be configured to receive an access token event from a terminal device communicatively coupled with the central server computer system. The access token event may indicate that an access device associated with the terminal device has received an access token. The session module may be configured to identify a virtual session associated with the received access token event. The rules engine module may be configured to apply a set of rules to the received access token event and the identified virtual session to determine an action associated with the identified virtual session. The instruction module may be configured to transmit an instruction to at least one device communicatively coupled with the central server computer system to carry out the action associated with the identified virtual session. The central server computer system of the second set of illustrative embodiments may be configured to perform one or more aspects of the functionality described above with reference to the method of the first set of illustrative embodiments.

According to a third set of illustrative embodiments, a computer program product may include a tangible computer readable device having computer readable instructions stored thereon. The computer readable instructions may include: computer readable program instructions configured to cause at least one processor to receive an access token event at a central server computer system from a terminal device, the access token event indicating that an access device associated with the terminal device has received an access token; computer readable program instructions configured to cause the at least one processor to identify at the central server computer system a virtual session associated with the received access token event; computer readable program instructions configured to cause the at least one processor to apply a set of rules to the received access token event and the identified virtual session to determine an action associated with the identified virtual session; and computer readable program instructions configured to cause the at least one processor to transmit an instruction to at least one device communicatively coupled with the central server computer system to carry out the action associated with the identified virtual session. The computer program product of the third set of illustrative embodiments may be configured to perform one or more aspects of the functionality described above with reference to the method of the first or second set of illustrative embodiments.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention.

FIG. 2 is a block diagram of an example system including components configured according to various embodiments of the invention.

FIGS. 3A-3C are diagrams of an example system including components configured according to various embodiments of the invention.

FIGS. 4A-4B are diagrams of an example system including components configured according to various embodiments of the invention.

FIGS. 5A-5C are diagrams of an example system including components configured according to various embodiments of the invention.

FIGS. 6A-6D are diagrams of an example system including components configured according to various embodiments of the invention.

FIGS. 7A and 7B are block diagrams of example central server computer systems according to various embodiments of the invention.

FIG. 8 is a block diagram of an example terminal device according to various embodiments of the invention.

FIG. 9 is a flowchart diagram of an example method of access token event virtualization according to various embodiments of the invention.

FIG. 10 is a flowchart diagram of an example method of access token event virtualization according to various embodiments of the invention.

FIG. 11 is a flowchart diagram of an example method of access token event virtualization according to various embodiments of the invention.

FIG. 12 is a schematic diagram that illustrates a representative device structure that may be used in various embodiments of the present invention.

### DETAILED DESCRIPTION OF THE INVENTION

Methods, systems, and devices are disclosed for managing access token events at a virtualized environment implemented by a central server computer system instead of at a local operating system of a terminal device connected to the access device. The virtualization of access token event management may enable the analysis of access token events at a global level of the network to orchestrate actions with respect to host devices and terminal devices that do not have direct access to the access device.

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

As used herein, the term “access token” or “token” refers to a digital representation of an authentication credential (e.g., proximity card data, magnetic card swipe, Personal Identification Number (PIN) or other user identifier, username, password, Near Field Communications (NFC) data, biometric data, etc.) as received at an access device.

As used herein, the term “access token event” refers to an electronic record that an access token has been received at an access token device. An access token event may, but does not necessarily, include the received access token.

As used herein, the term “virtual session” or “session” refers to a hosted session of a virtual computing environment associated with a particular user that may be accessed from one or more client devices other than the host. For example, a session may include a thin client session, a virtual application session, a virtual machine session, a virtual operating system session, and/or the like. As used herein, a session described as being “between” a host device and a terminal device refers to the exchange of data between the host device and the terminal device, where the data is related to the session hosted at the host device.

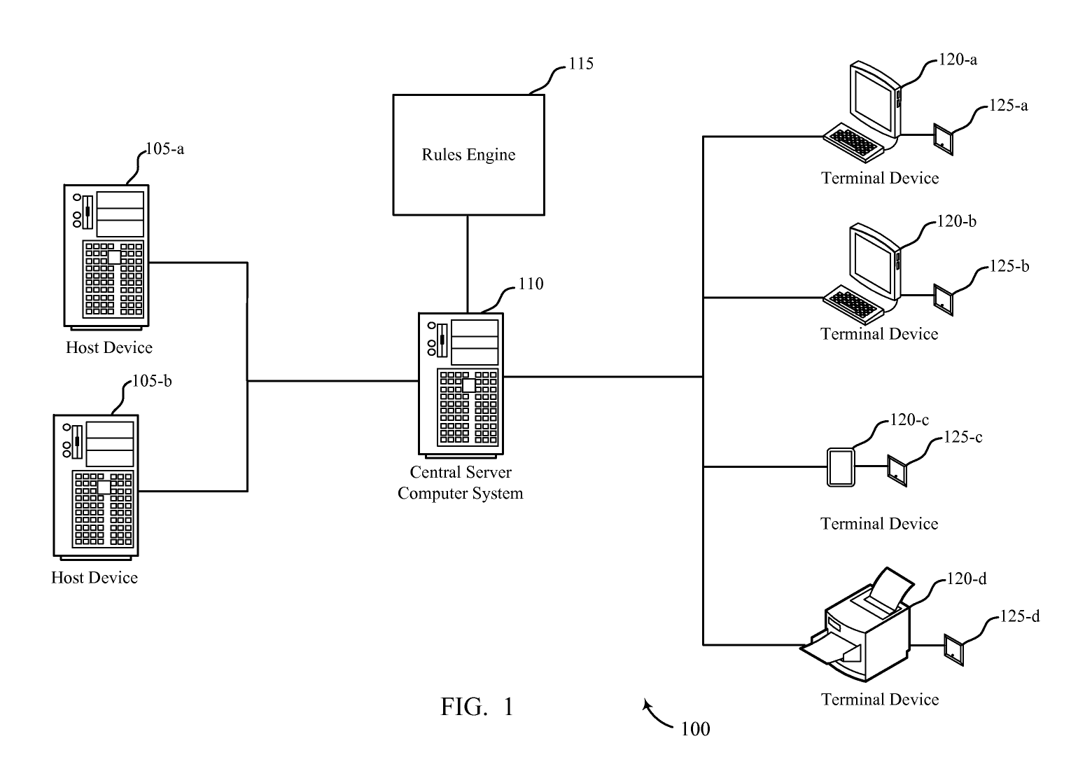

FIG. 1 illustrates an example system 100 including host devices 105, a central server computer system 110, a rules engine 115, terminal devices 120 (e.g., workstation 120-a, workstation 120-b, smartphone 120-c, and printer 120-d), and access devices 125 (e.g., proximity card readers 125). Each of these components may be in communication, directly or indirectly.

In the system 100 of FIG. 1, the central server computer system 110 may be communicatively coupled with a number of host devices 105 and terminal devices 120. The central server computer system 110 may be configured to forward network packets between the host devices 105 and the terminal devices 120. The central server computer system 110 may be implemented by a single server device or by a number of related components interconnected over a network. A single host device 105 may include one or more servers. Each of the host devices 105 may be configured to provide one or more services. These services may vary in scope and function. In certain examples, the central server computer system 110 may implement one or more of the host devices 105.

In one example, a number of host devices 105 may host virtual sessions on behalf of users of the terminal devices 120. Each virtual session hosted at a host device 105 may be associated with a particular user. A user may access a session hosted by a host device 105 through one of the terminal devices 120. A terminal device 120 may function as a thin client, and the host device 105-a may provide operating system functionality remotely to the terminal device 120 while the terminal device 120 provides keyboard, video, and mouse (KVM) functionality for the session to the user. Alternatively, the terminal device 120 may execute the operating system for a virtual session based on settings, configurations, applications, or other data provided for the user from the centralized host device 105.

Each of the access devices 125 may be configured to receive access tokens from users. In the present example, the access devices 125 are proximity card readers. Alternatively, one or more of the access devices 125 may include biometric readers, keypads, magnetic card readers, wireless transceivers for communicating with mobile devices, or other types of access devices. When a user provides an access token to an access device 125, rather than processing of the received access token only in the operating system of the terminal device 120 associated with the access device 125, the terminal device 120 may generate an access token event and transmit the access token event to the central server computer system 110. The central server computer system 110 may apply a set of rules from the rules engine 115 to the access token event to determine one or more appropriate actions to take based on the access token event. The central server computer system 110 may then take the appropriate action or instruct a terminal device 120 or host device 105 to take the appropriate action. Thus, through the centralized virtualization of the access token event processing, the access token event generated at a local terminal device 120 may affect other terminal devices 120, one or more of the host devices 105, or the central server computer system 110.

In one example, a user of a terminal device 120 may log onto a system by providing a first access token to the access device 125 associated with a terminal device 120 (e.g., by tapping a key card to a reader associated with a terminal workstation). As described above, the terminal device 120 may detect that the access device 125 has received an access token, generate an access token event, and transmit the access token event to the central server computer system 110 for processing. The access token event may include the access token received at the access device 125.

The central server computer system 110 may apply a set of rules at rules engine 115 to identify the user based on the received access token event and determine that a virtual session is currently being hosted for the user at a host device 105-a. Based on the set of rules and the received access token event, the central server computer system 110 may instruct the terminal device 120 to prompt the user for further credentials to authenticate the user, update the existing virtual session at the host device 105 based on the location of the terminal device 120, prepare to switch KVM data for the session to the terminal device 120, and instruct another terminal device 120 previously associated with the virtual session to log the user out. Once the user completes the authentication process, the virtual session associated with the user may immediately appear on the terminal device where the user is currently located.

In certain examples, at least a portion of the rules engine 115 may be implemented by or within the central server computer system 110. Additionally or alternatively, at least a portion of the rules engine 115 may be implemented by a device external to the central server computer system 110. The rules engine 115 may apply or enforce a set of event-based rules for dynamically modifying certain aspects of the virtual sessions, creating and tearing down virtual sessions, and multiplexing the session data between the host devices 105 and the terminal devices 120. The central server computer system 110 may selectively forward session data between the host devices 105 and the terminal devices 120 based on the logical deductions of the rules engine 115.

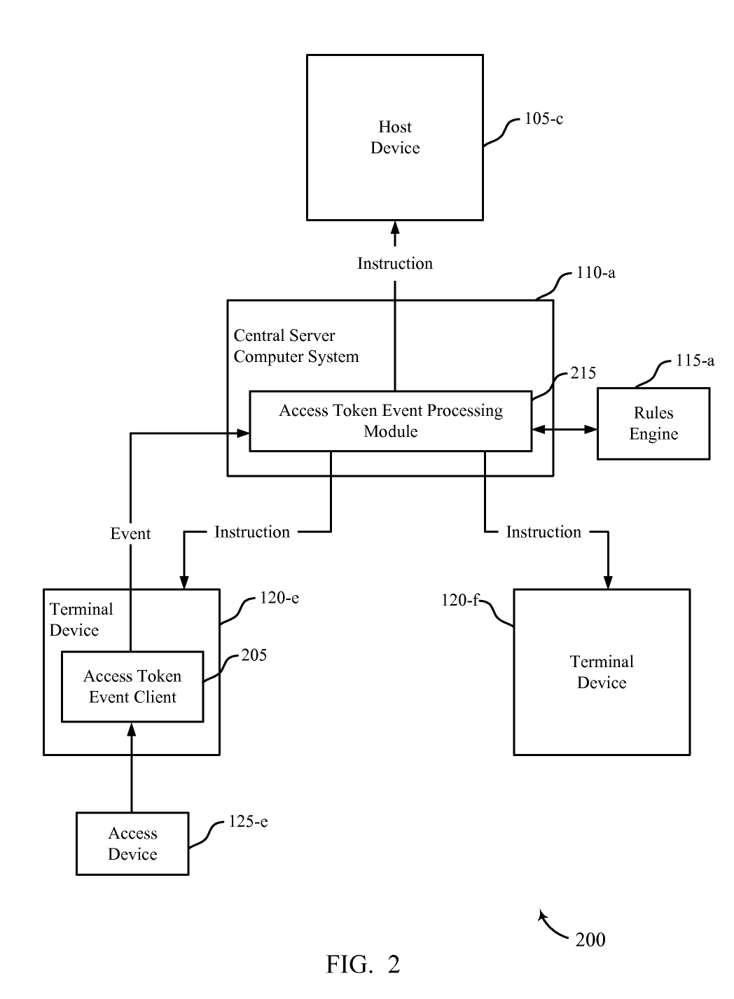

FIG. 2 is a block diagram of another example system 200 according to the principles described herein. The system 200 of the present example includes a central server computer system 110-a communicatively coupled with a number of terminal devices 120 and a rules engine 115-a. The central server computer system 110-a may be further coupled with a number one or more host devices 105-c configured to execute virtual sessions on behalf of the users of the terminal devices 120. The system 200 may be an example of the system 100 described above with reference to FIG. 1.

In the present example, a first terminal device 120-e may be communicatively coupled with an access device 125-e configured to receive access tokens from users. The access device 125-e may be a peripheral device of the terminal device 120-e. The terminal device 120-e may be configured to locally execute an access token event client 205 to manage the access device 125-e and listen for new access tokens. When the access device 125-e receives an access token from a user, the access device 125-e may communicate to the terminal device 120-e that the access token has been received. The access token event client 205 of the terminal device 120-e may accordingly generate an access token event based on the access token received at the access device 125-e. Thus, instead of processing the received access token only at the terminal device 120-e, the access token event client 205 may transmit the generated access token event to the central server computer system 110-a for centralized processing and event-driven actions.

The central server computer system 110-a may implement an access token event processing module 215 that receives access token events from the terminal devices 120, consults the rules engine 115-a to identify one or more appropriate actions based on the received access token event, and causes the actions to be executed at the host devices 105, the terminal devices 120, the central server computer system 110, or other appropriate locations. Functional components of the rules engine 115-a may be implemented within the central server computer system 110-a or separate from the central server computer system 110-a.

Example actions that may be taken by the central server computer system 110-a based on a received access token event may include actions for ascertaining the identity of the user who provided the access token (e.g., instructing the terminal device 120-e to prompt the user for additional authentication information) or the location of the user (e.g., contacting a data store to identify a region associated with the terminal device 120-e or the user). In additional or alternative examples, the actions associated with the received access token event may include actions related to the management of virtual sessions, such as creating a new virtual session at a host device 105-c, associating an existing virtual session with a new or different terminal device 120, logging a user on or off of a session, mirroring or sharing virtual session data to multiple terminal devices 120, tearing down a virtual session, changing a security profile associated with the session, and the like.

The rules implemented at the rules engine 115-a based on the received access token event may update one or more aspects, settings, and/or access permissions of a new or existing virtual session, applicable to individual users, types of users, sessions, types of sessions, applications, specific client devices, types of devices, etc. The rules may apply to a particular terminal device 120, all terminal devices 120 in an area, or certain types of terminal devices 120 in an area. The aspects and settings of the session may, for example, relate to an appearance of a user interface for the session, the status of one or more applications within or associated with the session, the value of one or more session variables, the association of one or more printers or other default peripheral devices with the session, and/or the like. The access permission rules may relate to controlling, restricting, manipulating, or restricting resources. Resources may include applications, computing resources, network resources, system resources.

Various types of action may be initiated according to the one or more rules implemented by the rules engine 115-a. In certain examples, the action may be to allow or block access to a resource, such as, for instance, a folder in a network drive, an application, and/or a network. In additional or alternative examples, the action may be to create, open, close, or delete an application, a file, a user profile, a setting, or the like. In still other additional or alternative examples, the action may be to open or hide a certain aspect of the session. For instance, an application associated with the session may continue to run in the background, but the access permission rule may hide the application from the user, thereby preventing the user from viewing or access the running application through the session. Additionally or alternatively, the action may affect some other aspect of the user interface of the session, such as minimizing or maximizing a certain application, file, or folder; reordering the display of graphical elements in the session; moving graphical elements in the session; drawing certain graphical elements in the session; painting certain graphical elements in the session; filling certain graphical elements in the session; clearing certain graphical elements in the session; and/or coloring certain graphical elements in the session.

In additional or alternative examples, the action initiated according to the one or more rules implemented at the rules engine 115-a may include displaying certain text or graphics to the user, prompting the user to provide textual or other input to the session, and/or initiating communications via input/output (I/O) devices or ports. In still other additional or alternative examples, the action may include modifying a session variable based on the second location, associating or disassociating one or more printers or other peripheral devices with the session based on the second location, and/or modifying a security setting associated with the session based on the second location.

As shown in FIG. 2, the central server computer system 110-a may transmit instructions to one or more host devices 105 or terminal devices 120 to execute the action(s) associated with the received access token event.

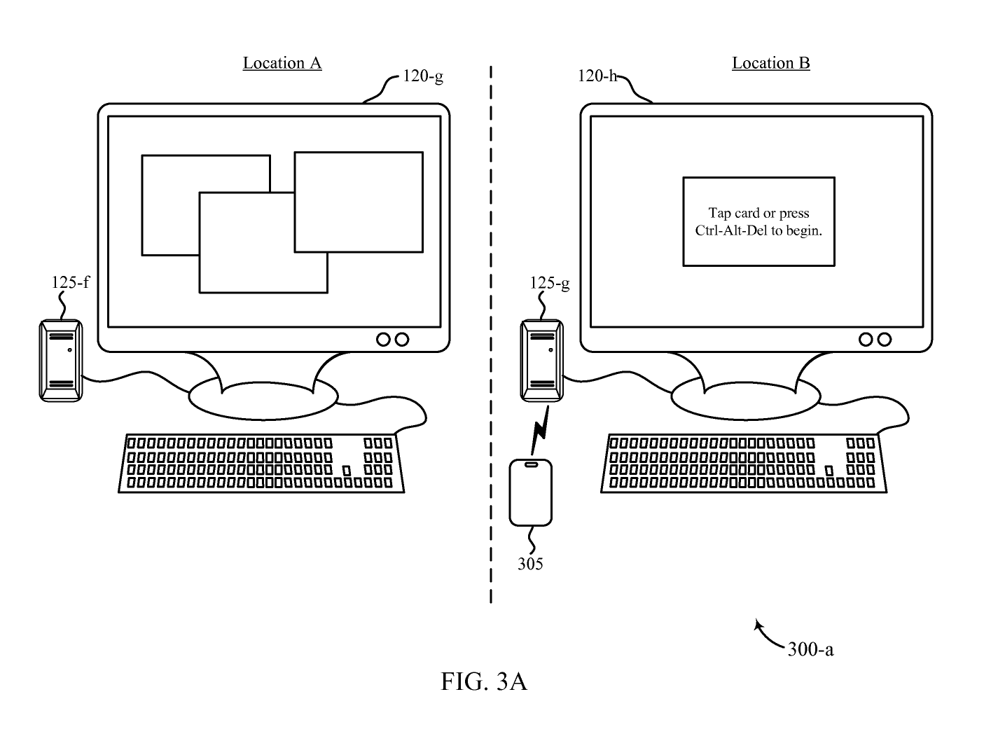

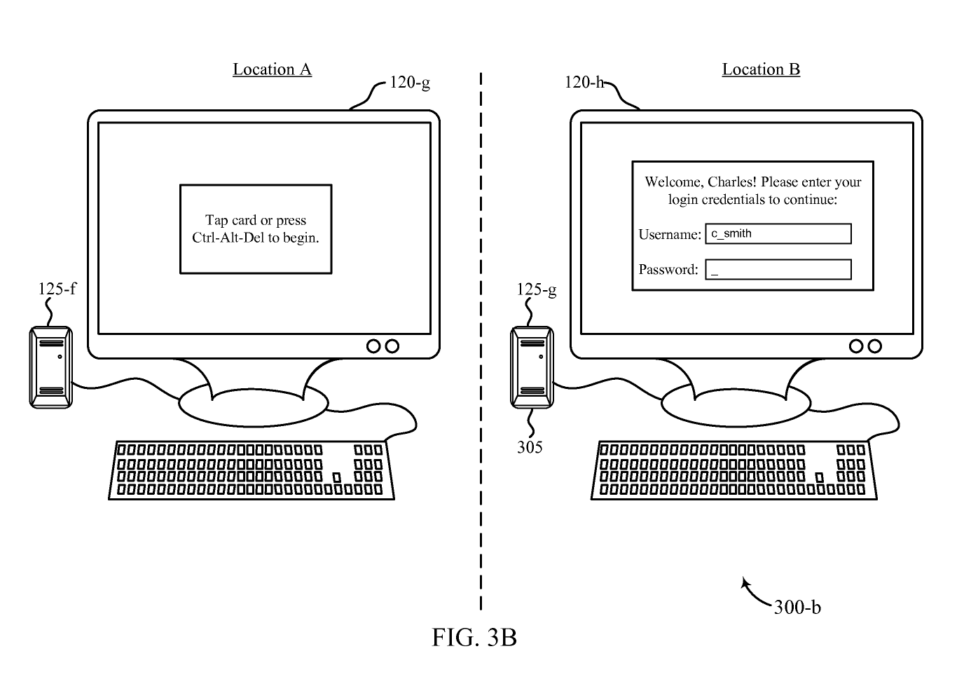

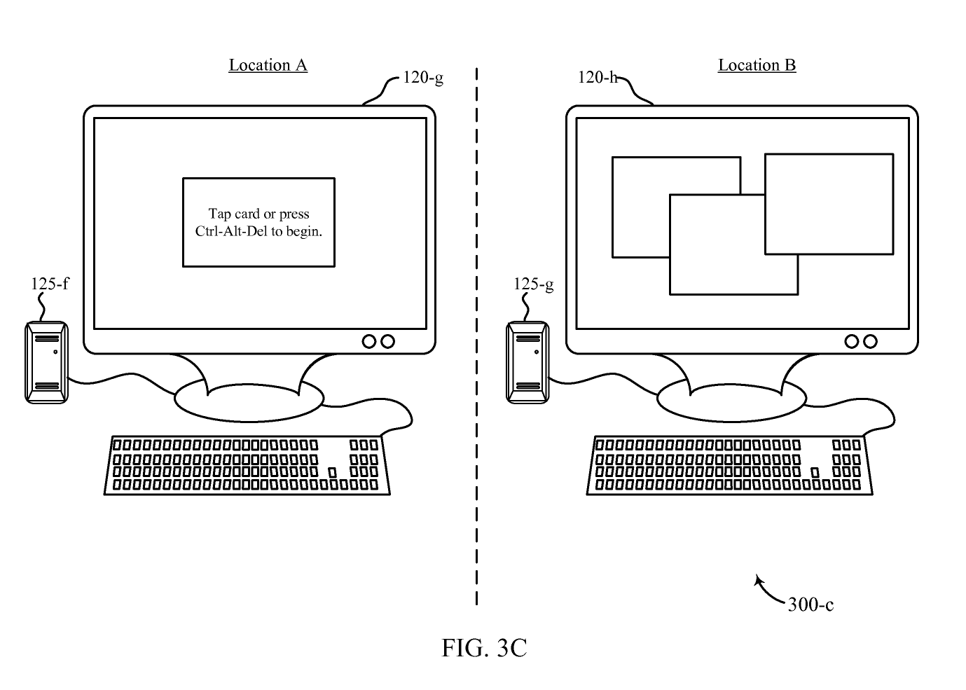

FIGS. 3A-3C show an example system 300 according to the principles described herein at different points in time. The system 300 of the present example may include a first terminal device 120-g and a second terminal device 120-h. Each of these terminal devices 120 may be associated with a proximity card reader access device 125. The terminal devices 120 may be examples of the terminal devices 120 described above with reference to FIGS. 1-2 and the proximity card reader access devices 125 may be examples of the access devices 125 described above with reference to FIGS. 1-2. The system 300 may be an example of one or more of the systems 100, 200 described above with reference to FIGS. 1-2, and the terminal devices 120 of FIGS. 3A-3C may each be communicatively coupled with a common central server computer system (e.g., the central server computer system 110 of FIG. 1 or FIG. 2). One or more host devices (e.g., host devices 105 of FIG. 1 or FIG. 2) may be configured to execute virtual sessions for which KVM data is routed to and from the terminal devices 120 by way of the central server computer system.

FIG. 3A shows an example of the system 300 at a first point in time, in which terminal device 120-g at Location A is associated with a user. As shown in FIG. 3A, terminal device 120-g may display a virtual desktop for a virtual session associated with a user. The virtual desktop may be provided to the terminal device 120-g by a host device by way of the central server computer system. Additionally or alternatively, the central server computer system may be the host device.

As shown in FIG. 3A, the user may leave the virtual desktop open on the terminal device 120-g at Location A, move from Location A to Location B, and tap a proximity card 305 associated with the user at the proximity card reader access device 125-g associated with terminal device 120-h at Location B. This tap of the proximity card 305 may cause the proximity card reader access device 125-g associated with terminal device 120-h to communicate with the proximity card 305 to receive an access token stored on the proximity card 305. The proximity card reader 125-g may pass the received access token to an access token event client (e.g., access token event client 205 of FIG. 2) running on terminal device 120-h, which may generate an access token event and forward the access token event to the central server computer system. The access token event may include the actual access token received at the proximity card reader 125-g.

The central server computer system may apply a number of rules to the received access token event to identify the user from the access token event and determine that the user has moved from terminal device 120-g to terminal device 120-h. Consequently, the central server computer system may take action to disassociate terminal device 120-g from the existing virtual session for the user and begin associating terminal device 120-h with the session. The central server computer system may additionally instruct terminal device 120-h to prompt the user for further authentication credentials, in this case a password.

FIG. 3B illustrates the system 300-b at a point in time after the central server computer system has taken these actions. As shown in FIG. 3B, the virtual desktop of the virtual session associated with the user may be removed from the screen of terminal device 120-g, and terminal device 120-g may revert to a generic login screen. On the other hand, terminal device 120-h may display a prompt for the user to enter a password to complete the authentication of the user before giving the user access to the running virtual session associated with the user. In the present example, the central server computer system may identify a username associated with the user and populate the username of the user in the prompt displayed on terminal 120-h. By centralizing the management of access token events at the central server computer system, both of the terminal devices 120 of the present example may be managed and updated by the central sever computer system in response to a single tap of proximity card (or other access token event) at a single location.

FIG. 3C illustrates the system 300-c at a point in time after the user has entered a password at terminal device 120-h and been fully authenticated at the central server computer system or another trusted device. Thus, the virtual session of the user may be associated with terminal 120-h at the central server computer system, and the virtual desktop of the virtual session associated with the user may transferred to terminal device 120-h by the central server computer system for KVM functionality.

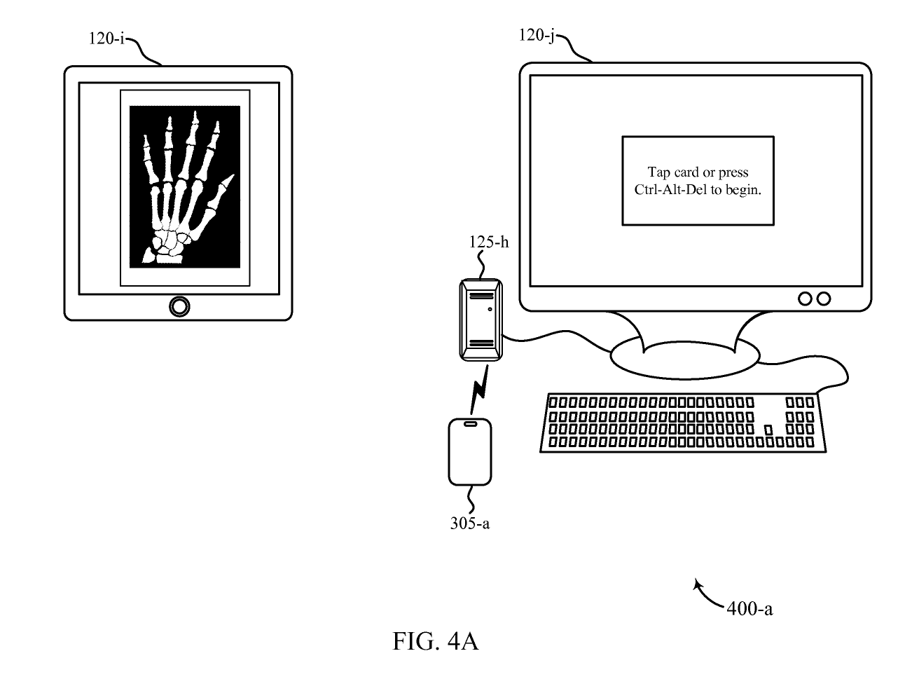

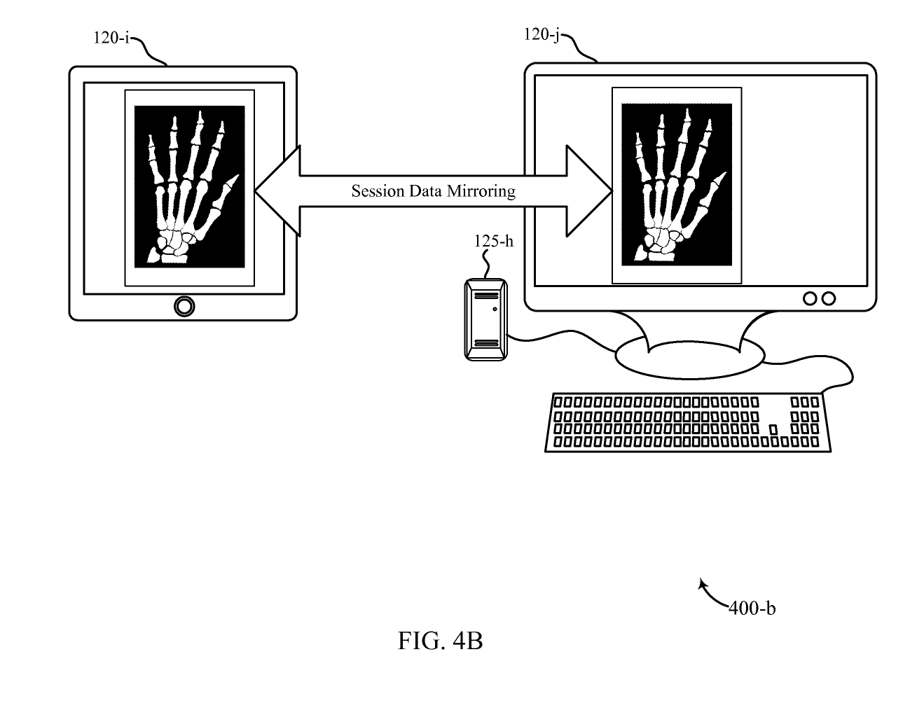

FIGS. 4A-4B show another example of a system 400 according to the principles described herein at different points in time. The system 400 of the present example may include a portable tablet terminal device 120-i and a workstation terminal device 120-j. The workstation terminal device 120-j may be associated with a proximity card reader access device 125-h. The terminal devices 120 may be examples of one or more of the terminal devices 120 described above with reference to FIGS. 1-3, and the proximity card reader access device 125-h may be an example of one or more of the access devices 125 described above with reference to FIGS. 1-3.

The system 400 may be an example of one or more of the systems 100, 200, 300 described above with reference to FIGS. 1-4, and the terminal devices 120 of FIGS. 4A-4B may each be communicatively coupled with a common central server computer system (e.g., the central server computer system 110 of FIG. 1 or FIG. 2). One or more host devices (e.g., host devices 105 of FIG. 1 or FIG. 2) may be configured to execute virtual sessions for which KVM data is routed to and from the terminal devices 120 by way of the central server computer system. Additionally or alternatively, the central server computer system may perform the functionality of a host device.

In the present example, the tablet terminal device 120-i may be associated with a virtual session of a user. The tablet terminal device 120-i may accordingly display a user interface for the virtual session. Because the tablet terminal device 120-i may be portable, the user may carry the tablet terminal device 120-i from location to location while accessing the virtual session. The different locations may be associated with different workstation terminal devices 120. The user may wish to mirror the user interface of his or her virtual session on the workstation terminal device 120-j associated with the current location of the user. In such examples, the user may, as shown in FIG. 4A, tap a proximity card 305-a to proximity card access device 125-h, thereby providing an access token of the user to the access device 125-h. The proximity card access device 125-h may notify workstation terminal device 120-j of the receipt of the access token, and workstation terminal device 120-j may generate an access token event for transmission to the central server computer system.

The central server computer system may recognize the access token event as being associated with the user of the tablet terminal device 120-i and identify the virtual session associated with the user. As shown in FIG. 4B, the central server may apply one or more rules to the received access token event and the virtual session to implement session data mirroring between the tablet terminal device 120-i and the workstation terminal device 120-j. Thus, the central server computer system may transmit all or a portion of the user interface of the virtual session of the user to both the workstation terminal device 120-j and the tablet terminal device 120-i. In the example of FIG. 4B, a selected window of the user interface may be mirrored to the workstation terminal device 120-j.

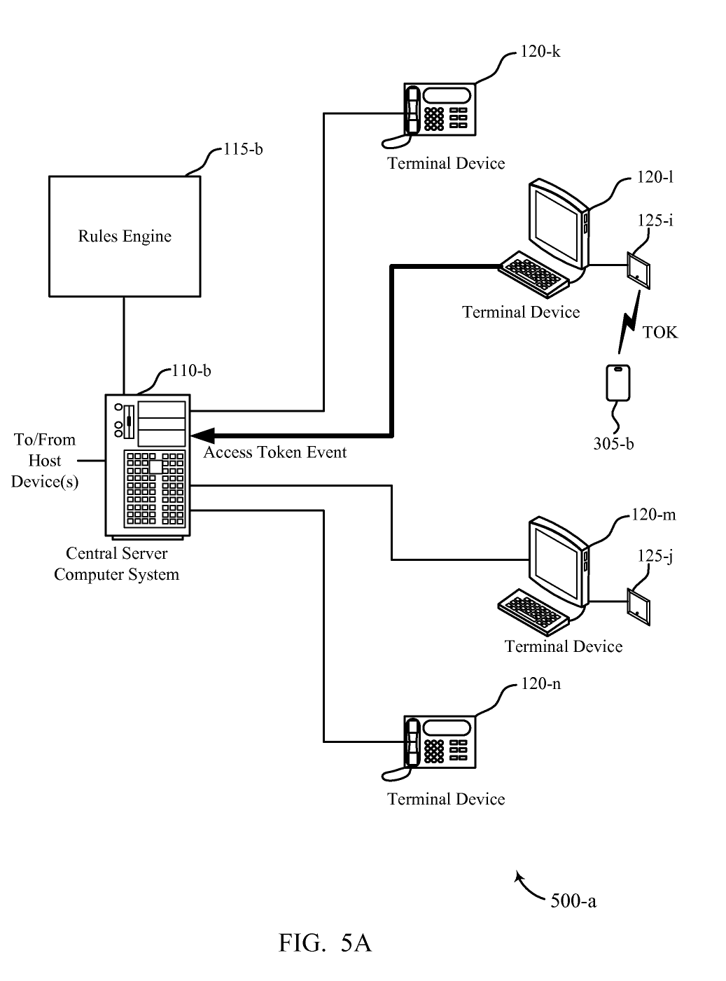

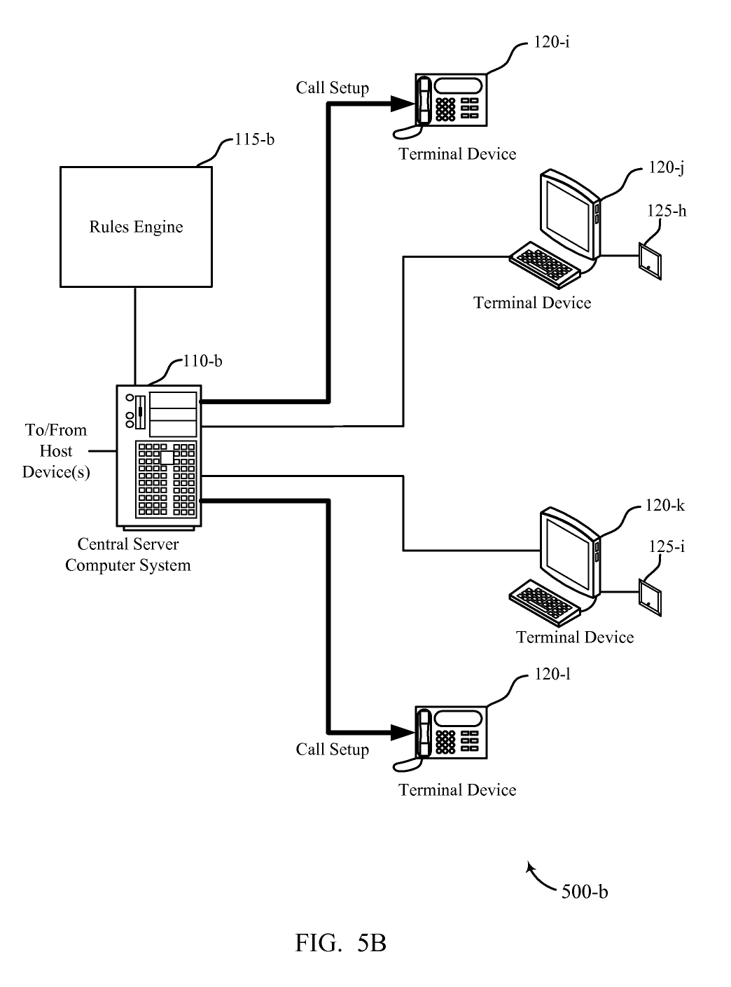

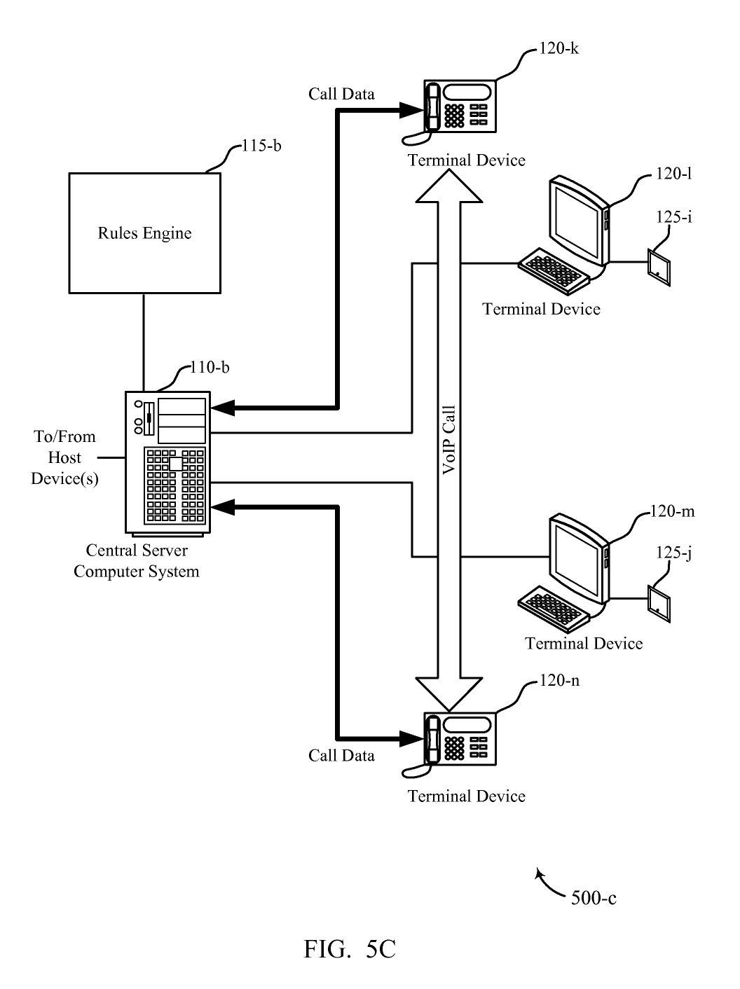

FIGS. 5A-5C show another example of a system 500 according to the principles described herein at different points in time. The system 500 may include a central server computer system 110-b, rules engine 115-b, telephone terminal devices 120-k, 120-n, and workstation terminal devices 120-l, 120-m. The workstation terminal devices 120-l, 120-m may be associated with separate proximity card reader access devices 125. The terminal devices 120 may be examples of one or more of the terminal devices 120 described above with reference to FIGS. 1-4, and the proximity card reader access devices 125 may be an example of one or more of the access devices 125 described above with reference to FIGS. 1-4.

The system 500 may be an example of one or more of the systems 100, 200, 300, 400 described above with reference to FIGS. 1-4, and the terminal devices 120 of FIGS. 5A-5C may each be communicatively coupled with the central server computer system 110-b. One or more host devices (e.g., host devices 105 of FIG. 1 or FIG. 2) may be configured to execute virtual sessions for which KVM or other (e.g., audio) data may be routed to and from the terminal devices 120 by way of the central server computer system 110-b. Additionally or alternatively, the central server computer system 110-b may perform the functionality of a host device.

In the present example, a first user in the proximity of workstation terminal device 120-l and telephone terminal device 120-k may choose to make a Voice over Internet Protocol (VoIP) to a second user in the proximity of workstation terminal device 120-m and telephone terminal device 120-n. There may be a rule set up at the rules engine 115-b which associates the receipt of an access token from the first user with setting up a call to the second user. Thus, as shown in FIG. 5A, the first user may provide his or her access token to the proximity card reader access device 125-i associated with terminal device 120-l using proximity card 305-b. The proximity card reader access device 125-i may communicate with the terminal device 120-l such that the terminal device 120-l may generate and transmit an access token event to the central server computer system 110-b.

Upon receiving the access token event, the central server computer system 110-b may identify the first user and a virtual session of the user based on the received access token event. The central server computer system 110-b may apply a set of one or more rules from the rules engine 115-b to the received access token event and the virtual session of the first user to determine that a call is to be setup between the first user and the second user. In certain examples, the central server computer system 110-b may identify a location and associated terminal devices 120-k, 120-l for the second user.

As shown in FIG. 5B, the central server computer system 110-b may update the virtual session of the first user and the virtual session of the second user to associate telephone terminal devices 120-i, 120-l with the respective virtual sessions and set up a VoIP call between telephone terminal device 120-i and telephone terminal device 120-l. As shown in FIG. 5C, once the VoIP call has been established between the telephone terminal devices 120-i, 120-l, the first user and the second user may access the call through their respective virtual sessions. In certain examples, the call may be routed through a publicly-switched telephone network (PSTN) in addition to or instead of setting up VoIP connectivity.

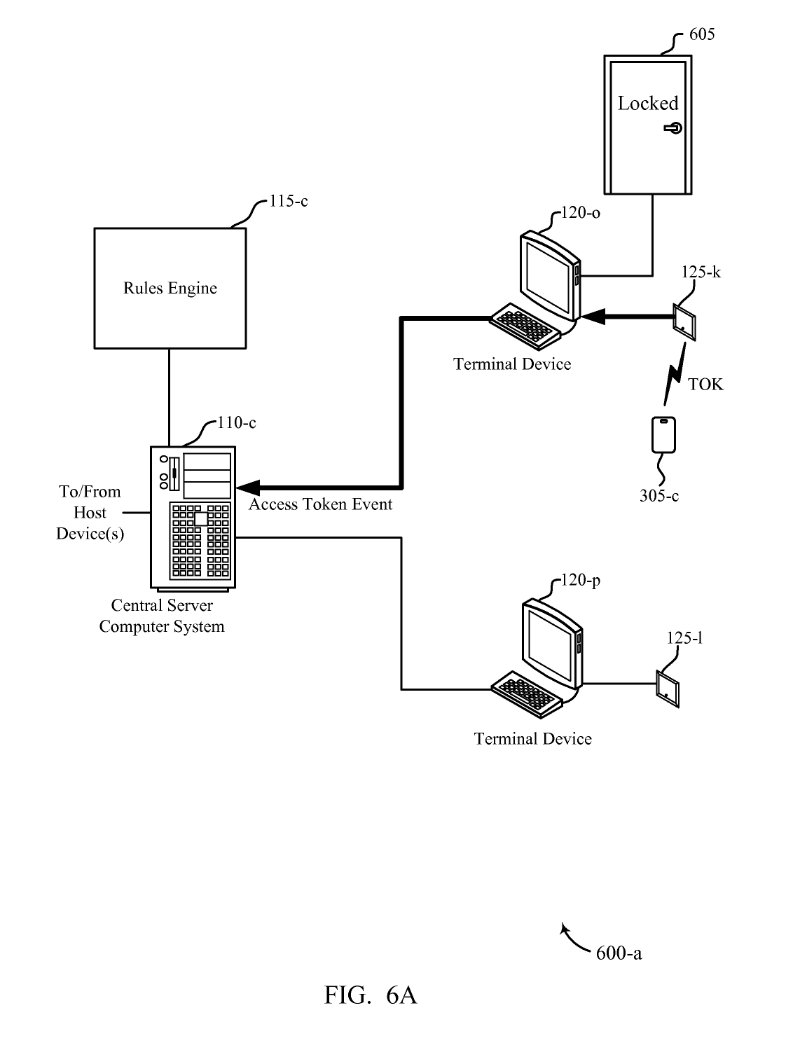

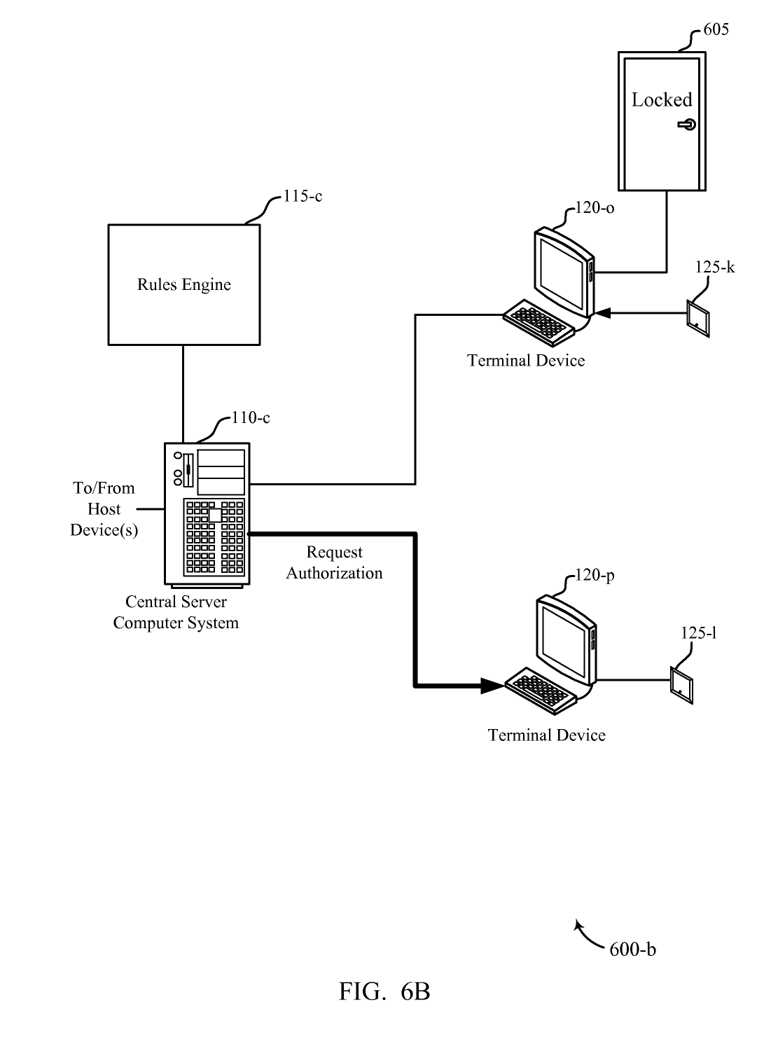

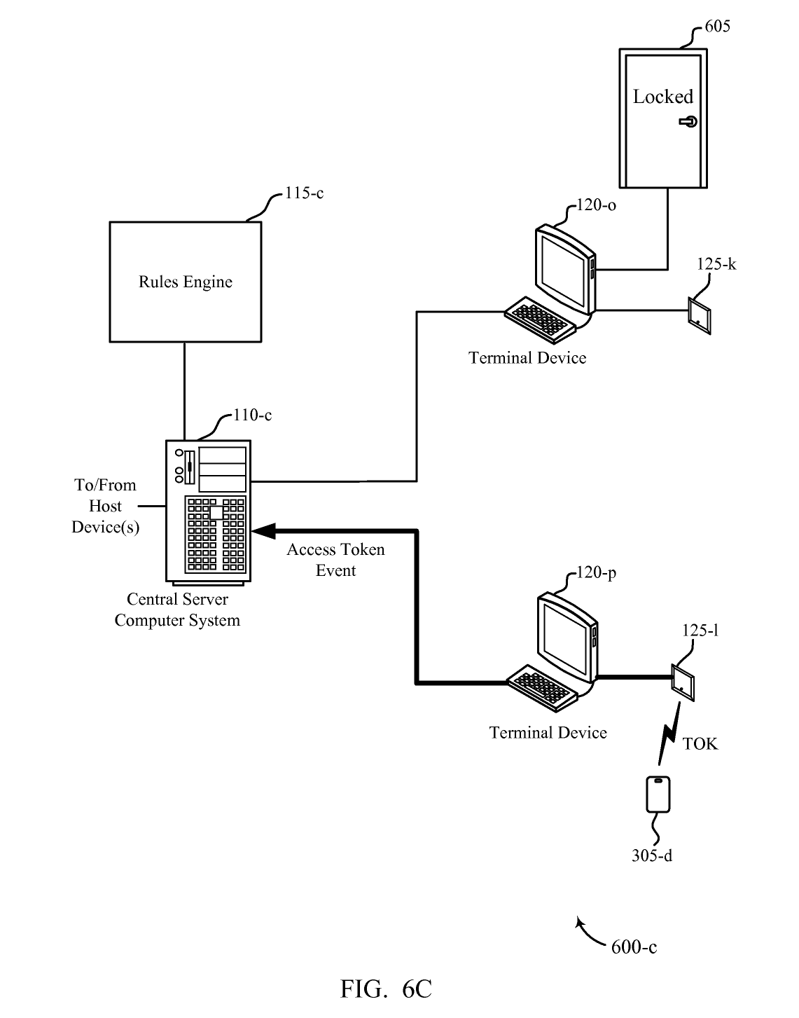

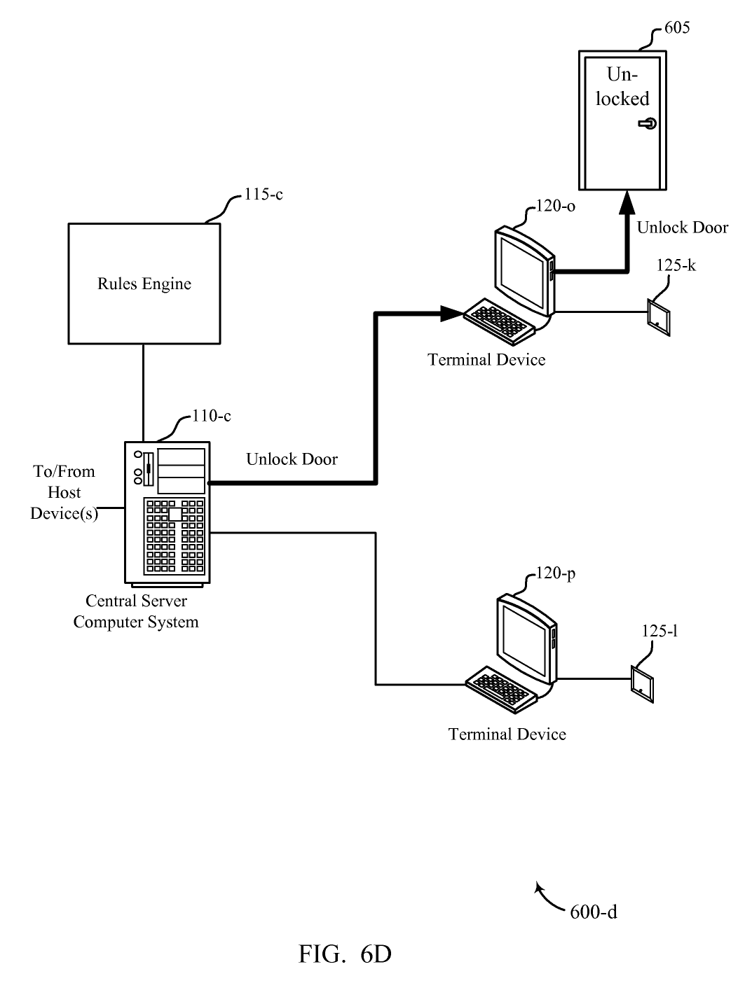

FIGS. 6A-6C show another example of a system 600 according to the principles described herein at different points in time. The system 600 may be configured to orchestrate multiple access token events from different access devices 125 to perform rules-based actions.

The system 600 of the present example may include a central server computer system 110-c, rules engine 115-c, and workstation terminal devices 120-o, 120-p. The workstation terminal devices 120-o, 120-p may be associated with separate proximity card reader access devices 125. In addition, workstation terminal device 120-o may be configured to control a locking mechanism associated with a door 605. The terminal devices 120 may be examples of one or more of the terminal devices 120 described above with reference to FIGS. 1-5, and the proximity card reader access devices 125 may be an example of one or more of the access devices 125 described above with reference to FIGS. 1-5.

The system 600 may be an example of one or more of the systems 100, 200, 300, 400, 500 described above with reference to FIGS. 1-5, and the terminal devices 120 of FIGS. 6A-6C may each be communicatively coupled with the central server computer system 110-c. One or more host devices (e.g., host devices 105 of FIG. 1 or FIG. 2) may be configured to execute virtual sessions for which KVM or other (e.g., audio) data may be routed to and from the terminal devices 120 by way of the central server computer system 110-c. Additionally or alternatively, the central server computer system 110-c may perform the functionality of a host device.

At FIG. 6A, a first user may wish to gain access to a protected environment through a locked door 605 controlled by terminal device 120-o. As such, the first user may tap a proximity card 305-c to proximity card reader access device 125-k to transfer an access token to the proximity card reader access device 125-k. The proximity card reader access device 125-k may communicate with the terminal device 120-o to generate an access token event, which may be transmitted to the central server computer system 110-c over a network.

Referring now to FIG. 6B, following receipt of the access token event, the central server computer system 110-c may identify the first user and determine that the first user is attempting to unlock door 605 based on the access token event. Based on the content of the received access token event, the central server computer system 110-c may use the rules engine 115-c to identify a second user from which authorization is to be received prior to allowing the first user through the secure door 605. In certain examples, the second user may be a supervisor specifically associated with the first user. Additionally or alternatively, the second user may be associated with the secure door 605. The central server computer system 110-c and/or rules engine 115-c may further identify a virtual session associated with the second user, and a terminal device 120-p currently tied to the virtual session of the second user.

The central server computer system 110-c and rules engine 115-c may identify, based on the access token event or the identified second user, an action for receiving authorization from the second user. For example, as shown in FIG. 6B, the central server computer system 110-c may prompt the second user at terminal device 120-p to provide an access token authorizing the first user to enter through door 605. In one example, the central sever computer system 110-c may update the virtual session of the second user such that the user interface transmitted by the central server computer system 110-c and displayed on terminal device 120-p includes the prompt to the second user.

Referring now to FIG. 6C, in response to the prompt, the second user may tap his or her proximity card 305-d at the proximity card reader access device 125-l associated with terminal device 120-p of the second user. Accordingly, the proximity card reader access device 125-l may communicate with the terminal device 120-p, and the terminal device 120-p may transmit an access token event to the central server computer system 110-c.

Referring now to FIG. 6D, the central server computer system and rules engine 115-c may apply one or more rules to the access token event received from the second user, and determine that the first user has been granted access to enter the secure door 605. Consequently, the central server computer system 110-c may transmit an instruction to the terminal device 120-o controlling the secure door 605 to unlock the door 605, and the first user may gain entry to the protected space behind the secure door 605.

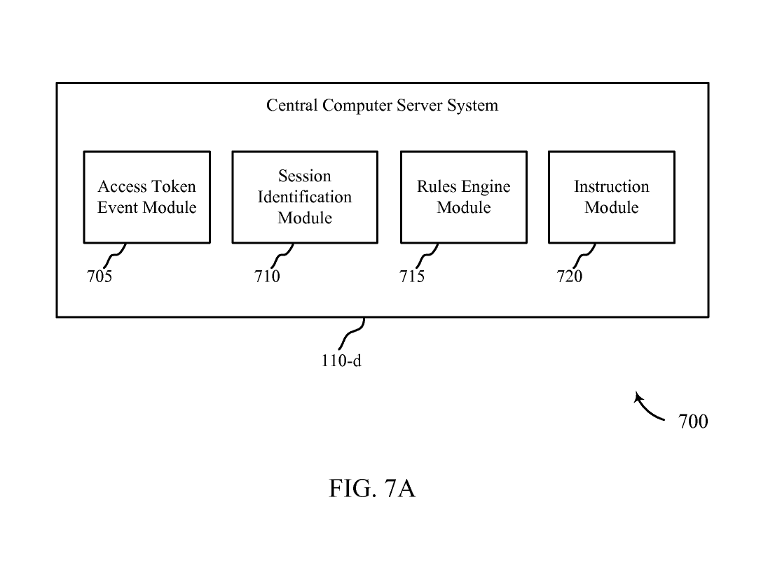

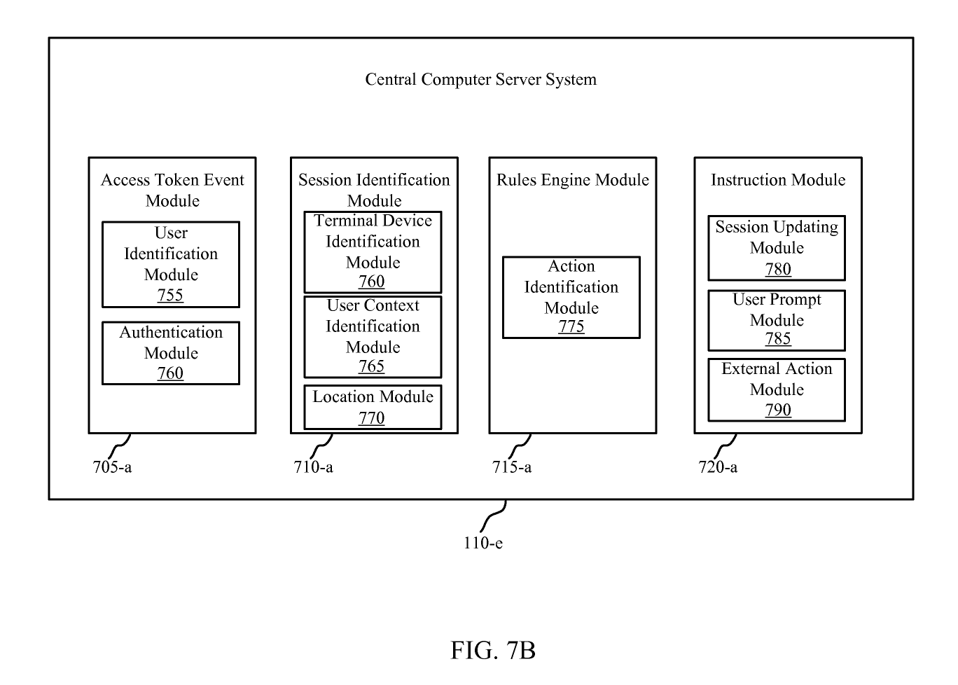

FIG. 7A is a block diagram 700 of an example central server computer system 110-d according to the principles described herein. The central server computer system 110-d may include an access token event module 705, a session identification module 710, a rules engine module 715, and an instruction module 720. Each of these modules may be in communication with each other module, directly or indirectly. The central server computer system 110-d may be an example of one or more of the central server computer systems 110 described above with reference to the previous Figures. In certain examples, one or more of these modules 705, 710, 715, 720 may be components of the access token event client 205 of FIG. 2.

Each module 705, 710, 715, 720 may be implemented by dedicated hardware, hardware executing software, software stored on a tangible physical medium, or combinations thereof. In certain examples, the same hardware may implement more than one of the modules 705, 710, 715, 720 of FIG. 7. Additionally or alternatively, the functionality of the modules 705, 710, 715, 720 of the central server computer system 110-d may be distributed across a system of interrelated hardware devices.

The access token event module 705 may be configured to receive an access token event from a terminal device over a network connection. The access token event may indicate that an access device associated with the terminal device has received an access token. The access token event may include part or all of the content of the access token received at the access device. The session identification module 710 may identify a virtual session associated with the received access token event. The rules engine module 715 may apply a set of rules to the received access token event and the identified session to determine an action to be taken with respect to the identified session. The instruction module 720 may transmit an instruction to at least one device communicatively coupled with the central server computer system to carry out the action with respect to the identified session. The at least one device may include one or more host devices or terminal devices.

FIG. 7B is a block diagram 750 of a more detailed example of a central server computer system 110-e according to the principles described herein. The central server computer system 110-e may include an access token event module 705-a, a session identification module 710-a, a rules engine module 715-a, and an instruction module 720-a. Each of these modules may be in communication with each other module, directly or indirectly. The central server computer system 110-e may be an example of one or more of the central server computer systems 110 described above with reference to the previous Figures. In certain examples, one or more of these modules 705-a, 710-a, 715-a, 720-a may be components of the access token event client 205 of FIG. 2.

The access token event module 705-a may be configured to receive an access token event from a terminal device. The access token event may indicate that an access device associated with the terminal device has received an access token. The access token event module 705-a may further include a user identification module 755 configured to identify a user associated with the access token received at the terminal device based on the access token event received at the central server computer system 110-e. The access token event module 705-a may further include an authentication module 760 configured to communicate with the terminal device to cause the terminal device to prompt a user associated with the access token for at least one authentication credential and receive the at least one authentication credential from the terminal device.

The session identification module 710-a may identify a virtual session associated with the received access token event. In certain examples, the session identification module 710-a may identify the virtual session based on the user identified at the user identification module 755. Additionally or alternatively, the session identification module 710-a may identify the virtual session based on a known relationship between the user identified at the user identification module 755 and a second user.

The session identification module 710-a may further include a terminal device identification module 760 configured to identify a terminal device associated with the identified virtual session, a user context identification module 765 configured to determine a context (e.g., current location, actions performed, time of day, status, job description, current terminal device, current responsibilities of a user of the identified virtual session, current security profiles, etc.) of a user associated with the identified virtual session. A location module 770 may be configured to determine a location associated with the identified virtual session (e.g., according to a stored variable, based on the location of a terminal device tied to the virtual session, based on the location of a user of the virtual session, based on GPS or other location sensing at the terminal device, etc.).

The rules engine module 715-a may apply a set of rules to the received access token event and/or the identified virtual session. The rules engine module 715-a may further include an action identification module configured to determine an action associated with the identified virtual session based on the application of the set of rules to the received access token event and/or the identified virtual session.

The instruction module 720-a may transmit an instruction to at least one device communicatively coupled with the central server computer system 110-d to carry out the action associated with the identified virtual session. The instruction module 720-a may further include a session updating module 780 configured to update one or more aspects of the identified virtual session based on the action associated with the identified session, as described above. In certain examples, the authentication module 760 of the access token event module 705-a may authenticate the user based on the at least one authentication credential, and the session updating module 780 of the instruction module 720-a may associate the virtual session identified at the session identification module 710-a with the terminal device in response to the authentication of the user.

The instruction module 720-a may further include a user prompt module 785 configured to prompt a user of the identified virtual session to enter a credential or perform some other action, and an external action module 790 configured to carry out one or more additional actions that may not necessarily be associated with the identified virtual session (e.g., actions that do not occur at terminal devices).

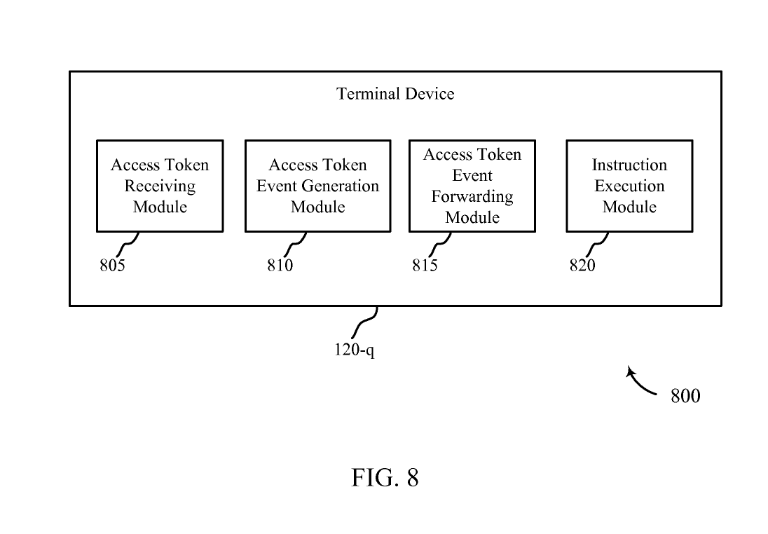

FIG. 8 is a block diagram 800 of an example terminal device 120-q according to the principles described herein. The terminal device 120-q may include an access token receiving module 805, an access token event generation module 810, an access token event forwarding module 815, and an instruction execution module 820. Each of these elements may be in communication, directly or indirectly. The terminal device 120-q may be an example of one or more of the terminal devices 120 described above with reference to the previous Figures.

Each module 805, 810, 815, 820 of the terminal device 120-q may be implemented by dedicated hardware, hardware executing software, software stored on a tangible physical medium, or combinations thereof. In certain examples, the same hardware may implement more than one of the modules 805, 810, 815, 820 of the terminal device 120-q. Additionally or alternatively, the functionality of the modules 805, 810, 815, 820 of the terminal device 120-q may be distributed across a system of interrelated hardware devices.

The access token receiving module 805 may be configured to receive an access token from an access device associated with the terminal device. The access device may receive the access token over a wireless connection (e.g., RFID communication, Near Field Communication (NFC), Wireless Local Area Network (WLAN) communication, cellular communication, etc.) or a wired or other physical interface. The access token may include access credentials or other identifying information associated with a user or group of users.

The access token event generation module 810 may generate an access token event based on the received access token. In certain examples, the access token event may include one or more portions of the received access token. For example, the access token event may include one or more access credentials included in the received access token. Additionally or alternatively, the access token event may include a reference to the received access token that is understood by the central server computer system without including the actual received access token. For example, if the access token is a lengthy encrypted credential, the access token event generation module 810 may decrypt and decode the credential to determine a user associated with the credential, and generate a short access token event indicating that a credential for the identified user has been received.

The access token event forwarding module 815 may transmit the access token event to a central server computer system separate from the terminal device 120-q. The instruction execution module 820 may receive an instruction associated with a virtual session from the central server computer system in response to the access token event and execute the instruction to enforce an action with respect to the virtual session.

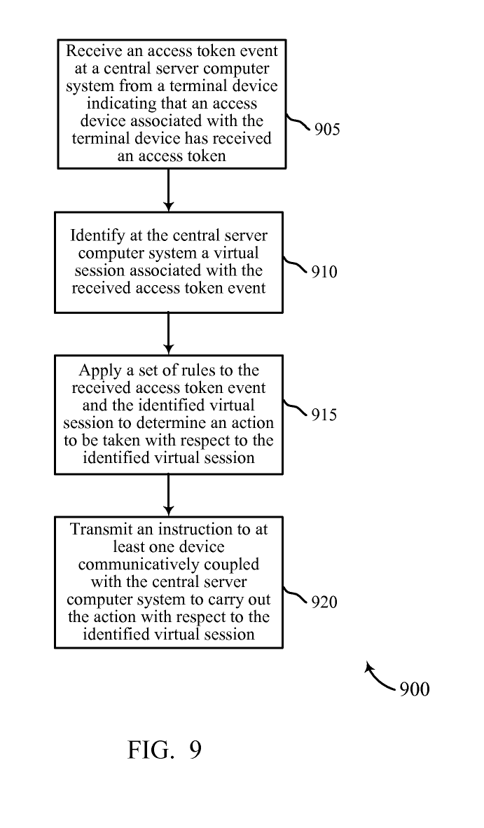

FIG. 9 illustrates a flowchart of an example of a method 900 of access token event virtualization. The method 900 may be performed, for example, by one or more of the central server computer systems 110 described above with reference to the previous Figures.

At block 905, an access token event may be received at a central server computer system from a terminal device, the access token event indicating that an access device associated with the terminal device has received an access token. At block 910, a virtual session associated with the received access token event may be identified. At block 915, a set of rules may be applied to the received access token event and the identified session to determine an action to be taken with respect to the identified virtual session in response to the occurrence of the access token event. At block 920, an instruction may be transmitted to at least one device communicatively coupled with the central server computer system to carry out the action with respect to the identified session.

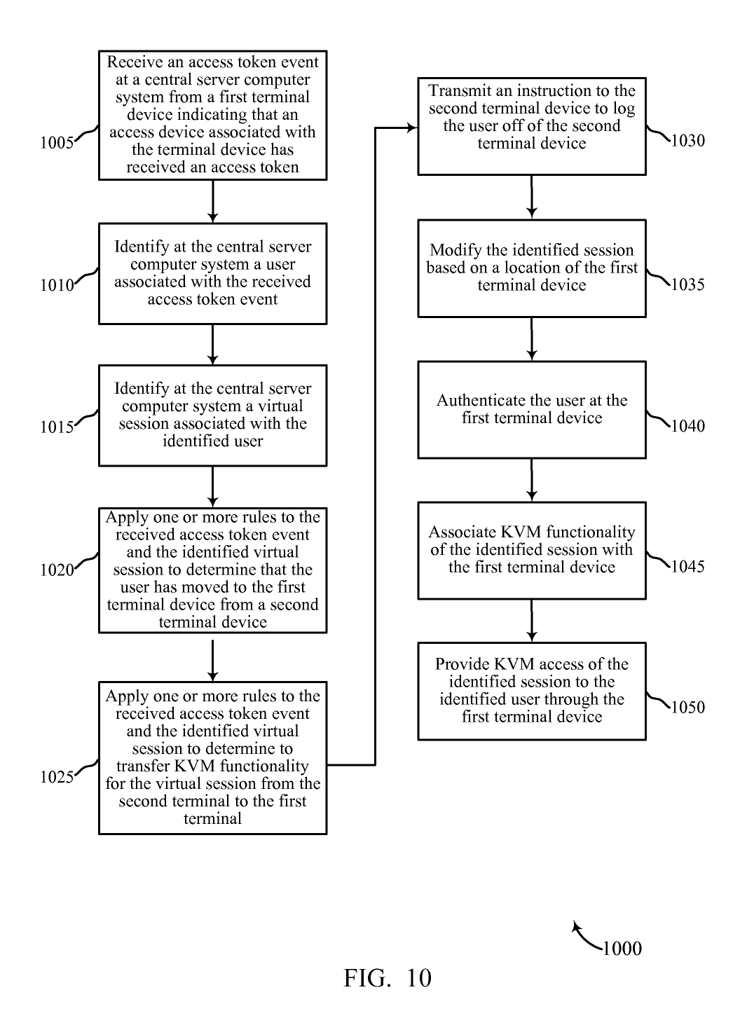

FIG. 10 illustrates a flowchart of another example of a method 1000 of access token event virtualization. The method 1000 may be performed, for example, by one or more of the central server computer systems 110 described above with reference to the previous Figures.

At block 1005, an access token event may be received at a central server computer system from a first terminal device. The access token event may indicate that an access device associated with terminal device has received an access token. At block 1010, a user associated with the received access token event may be identified at the central server computer system. At block 1015, the central server computer system may identify a virtual session associated with the identified user. At block 1020, one or more rules may be applied to the received access token event and the identified virtual session to determine that the user has moved to the first terminal device from a second terminal device.

At block 1025, one or more rules may be applied to the received access token event and the identified virtual session to determine to transfer keyboard, video, and mouse (KVM) functionality for the virtual session from the second terminal to the first terminal. At block 1030, an instruction may be transmitted to the second terminal device to log the user off of the second terminal device. At block 1035, the identified session may be modified based on a location of the first terminal device. At block 1040, the user may be authenticated at the first terminal device. At block 1045, KVM functionality of the identified session may be associated with the first terminal device. At block 1050, KVM access of the identified virtual session may be provided to the identified user through the first terminal device.

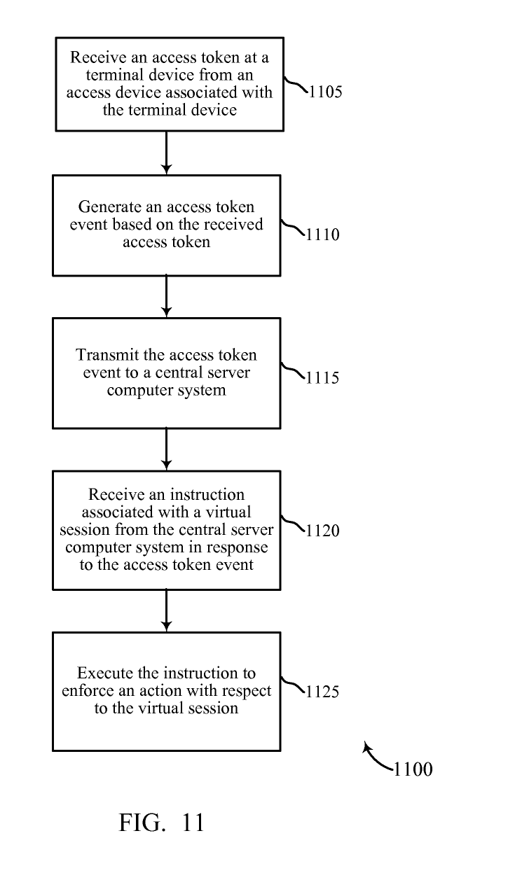

FIG. 11 illustrates a flowchart of another example method 1100 of access token event virtualization. The method 1100 may be performed, for example, by one or more of the terminal devices 120 described above with reference to the previous Figures.

At block 1105, an access token may be received from an access device associated with the terminal device. At block 1110, an access token event may be generated at the terminal device based on the received access token. At block 1115, the access token event may be transmitted to a central sever computer system communicatively coupled with the terminal device. At block 1120, an instruction associated with a virtual session may be received from the central server computer system in response to the access token event. At block 1125, the instruction may be executed at the terminal device to enforce an action with respect to the virtual session in response to the access token event.

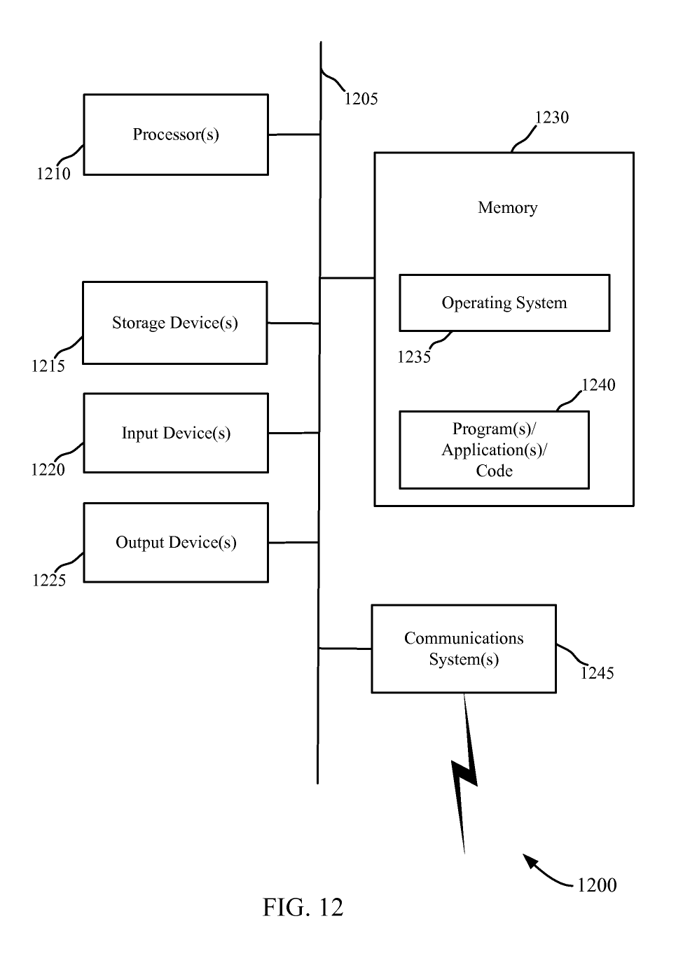

A device structure 1200 that may be used for a host device 105, a central server computer system 110, a rules engine 115, a terminal device 120, or other computing devices described herein, is illustrated with the schematic diagram of FIG. 12. This drawing broadly illustrates how individual system elements of each of the aforementioned devices may be implemented, whether in a separated or more integrated manner. The exemplary structure is shown comprised of hardware elements that are electrically coupled via bus 1205, including processor(s) 1210 (which may further comprise a DSP or special-purpose processor), storage device(s) 1215, input device(s) 1220, and output device(s) 1225. The storage device(s) 1215 may be a machine-readable storage media reader connected to any machine-readable storage medium, the combination comprehensively representing remote, local, fixed, or removable storage devices or storage media for temporarily or more permanently containing computer-readable information. The communications systems interface 1245 may interface to a wired, wireless, or other type of interfacing connection that permits data to be exchanged with other devices. The communications system(s) interface 1245 may permit data to be exchanged with a network.

The structure 1200 may also include additional software elements, shown as being currently located within working memory 1230, including an operating system 1235 and other code 1240, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

These components may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be executed by one or more general or application-specific processors.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a SIM card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of managing access tokens, the method comprising:
receiving an access token event at a central server computer system from a terminal device, the access token event indicating that an access device associated with the terminal device has received an access token;
identifying at the central server computer system a virtual session associated with the received access token event;
applying a set of rules to the received access token event and the identified virtual session to determine an action associated with the identified virtual session; and
transmitting an instruction to at least one device communicatively coupled with the central server computer system to carry out the action associated with the identified virtual session.

2. The method of claim 1, further comprising:
communicating with the terminal device to cause the terminal device to prompt a user associated with the access token for at least one authentication credential; and
receiving the at least one authentication credential at the central server computer system from the terminal device.

3. The method of claim 2, further comprising:
authenticating the user based on the at least one authentication credential; and
associating the identified virtual session with the terminal device at the central server computer system in response to the authentication of the user based on the at least one authentication credential.

4. The method of claim 1, wherein the at least one device communicatively coupled with the central server computer system comprises the terminal device, the action associated with the identified virtual session comprising:
selectively forwarding session data for the virtual session between the central server computer system and the terminal device.

5. The method of claim 4, further comprising:
determining at the central server computer system that a user associated with the virtual session has moved to a location of the terminal device based on the received access token event;
wherein the selectively forwarding the session data for the virtual session between the central server computer system and the terminal device occurs in response to the determination that the user has moved to the location of the terminal device.

6. The method of claim 5, further comprising:
updating at least one aspect of the virtual session based on the determination that the user has moved to the location of the terminal device.

7. The method of claim 4, wherein the action associated with the virtual session comprises:
causing a user interface for the virtual session to be displayed at the terminal device.

8. The method of claim 1, wherein the at least one device communicatively coupled with the central server computer system comprises a second terminal device associated with the virtual session.

9. The method of claim 8, wherein the action associated with the virtual session comprises:
disassociating the second terminal device from the virtual session at the central server computer system in response to receiving the access token event.

10. The method of claim 8, wherein the action associated with the virtual session further comprises:
logging the user off of the second terminal device.

11. The method of claim 8, wherein the action associated with the virtual session comprises prompting a user of the second terminal device to enter at least one authentication credential; the method further comprising:
receiving the at least one authentication credential from the second terminal device;
wherein the transmission of the instruction to carry out the action associated with the identified virtual session occurs in response to the at least one authentication credential received from the second terminal device.

12. A central server computer system configured to manage access tokens, the central server computer system comprising:
an access token event module configured to receive an access token event from a terminal device communicatively coupled with the central server computer system, the access token event indicating that an access device associated with the terminal device has received an access token;
a session module configured to identify a virtual session associated with the received access token event;
a rules engine module configured to apply a set of rules to the received access token event and the identified virtual session to determine an action associated with the identified virtual session; and
an instruction module configured to transmit an instruction to at least one device communicatively coupled with the central server computer system to carry out the action associated with the identified virtual session.

13. The central server computer system of claim 12, further comprising:
an authentication module configured to communicate with the terminal device to cause the terminal device to prompt a user associated with the access token for at least one authentication credential; and
receive the at least one authentication credential at the central server computer system from the terminal device.

14. The central server computer system of claim 13, wherein:
the authentication module is further configured to authenticate the user based on the at least one authentication credential; and
the session module is further configured to associate the identified virtual session with the terminal device at the central server computer system in response to the authentication of the user based on the at least one authentication credential.

15. The central server computer system of claim 12, wherein the at least one device communicatively coupled with the central server computer system comprises the terminal device, the action associated with the identified virtual session comprising:
selectively forwarding session data for the virtual session between the central server computer system and the terminal device.

16. The central server computer system of claim 15, further comprising:
a location module configured to determine that a user associated with the virtual session has moved to a location of the terminal device based on the received access token event;
wherein the selectively forwarding the session data for the virtual session between the central server computer system and the terminal device occurs in response to the determination that the user has moved to the location of the terminal device.

17. The central server computer system of claim 16, wherein the session module is further configured to:
update at least one aspect of the virtual session based on the determination that the user has moved to the location of the terminal device.

18. The central server computer system of claim 15, wherein the session module is further configured to:
cause a user interface for the virtual session to be displayed at the terminal device based on the authentication of the user and the association of the virtual session with the terminal device.

19. The central server computer system of claim 12, wherein the at least one device communicatively coupled with the central server computer system comprises a second terminal device associated with the virtual session.

20. The central server computer system of claim 19, wherein the action associated with the virtual session comprises:
disassociating the second terminal device from the virtual session at the central server computer system in response to receiving the access token event.

21. The central server computer system of claim 19, wherein the action associated with the virtual session further comprises:
logging the user off of the second terminal device.

22. The central server computer system of claim 19, wherein the action associated with the virtual session comprises prompting a user of the second terminal device to enter at least one authentication credential; the central server computer system further comprising:
an authentication module configured to receive the at least one authentication credential from the second terminal device;
wherein the transmission of the instruction to carry out the action associated with the identified virtual session occurs in response to the at least one authentication credential received from the second terminal device.

23. A computer program product, comprising:
a tangible computer readable device comprising computer readable instructions stored thereon, the computer readable program instructions comprising:
computer readable program instructions configured to cause at least one processor to receive an access token event at a central server computer system from a terminal device, the access token event indicating that an access device associated with the terminal device has received an access token;
computer readable program instructions configured to cause the at least one processor to identify at the central server computer system a virtual session associated with the received access token event;
computer readable program instructions configured to cause the at least one processor to apply a set of rules to the received access token event and the identified virtual session to determine an action associated with the identified virtual session; and
computer readable program instructions configured to cause the at least one processor to transmit an instruction to at least one device communicatively coupled with the central server computer system to carry out the action associated with the identified virtual session.
